(19) United States
(12) Patent Application Publication
(10) Pub. No.: US 2025/0052652 A1
(43) Pub. Date: Feb. 13, 2025

(54) METHOD FOR CONCENTRATION AND FOR AUTOMATED ONLINE DETECTION OF AT LEAST ONE BIOLOGICAL TARGET SUBSTANCE IN A SAMPLE LIQUID, AND CONCENTRATOR UNIT

(71) Applicant: IST Innuscreen GmbH, Berlin (DE)

(72) Inventor: Timo Hillebrand, Hönow (DE)

(21) Appl. No.: 18/722,654

(22) PCT Filed: Dec. 14, 2022
(86) PCT No.: PCT/EP2022/085796

§ 371 Date: Jun. 21, 2024

(30) Foreign Application Priority Data
Dec. 23, 2021 (DE) 10 2021 134 613.4

(51) Int. Cl. G01N 1/40; G01N 35/00

(52) U.S. Cl. CPC G01N 1/405; G01N 35/00584

(57) ABSTRACT

The invention relates to a method for concentrating at least one biological target substance in a sample liquid, which can be carried out using control electronics. The method includes metering and transporting a first initial volume of the sample liquid via a liquid supply line into a first concentrator chamber of a concentrator unit, and generating concentrated sample liquid by reducing the first initial volume of the sample liquid in the concentrator unit and associated concentration of the at least one biological target substance contained in the first volume of the sample liquid by means of a first amount of a superabsorber. The reduction and associated concentration is carried out by incubating a mixture formed from the first initial volume of the sample liquid with the first amount of the superabsorber.

The invention relates to a method for concentrating at least one biological target substance in a sample liquid, e.g., water or wastewater, and to a concentrator unit for the automated concentration of at least one biological target substance in a sample liquid. The invention also relates to a method for the automated on-line detection of at least one biological target substance by means of molecular-genetic methods in a sample liquid, e.g., water or wastewater, and to an on-line analyzer for the detection of at least one biological target substance by means of molecular-genetic methods in a sample liquid.

The detection of biological parameters is playing an increasingly important role in the process industry, for example in the monitoring and purification of industrial water or treated wastewater, in food production and in the pharmaceutical and life sciences sectors, for example in the monitoring of biotechnological processes carried out in fermenters. Target substances to be detected or monitored can be viruses, bacteria and plasmid-associated bacterial resistance genes, for example.

The detection of such biological target substances in liquids can be carried out with molecular-genetic methods, preferably using amplification techniques such as PCR or real-time PCR. For this purpose, samples of the liquid to be analyzed are taken and analyzed in specialized laboratories that have the necessary equipment systems. For automated sampling from processes, e.g. from clarifiers, fermenters, production vessels or pipes, manually operated or automatic sampling devices and sample collectors are known. The collected samples are usually transported to a laboratory for further analysis, where the extraction of the sample nucleic acids and the specific and, where applicable, quantitative detection of the biological target substance is carried out manually or at least in a partially automated manner.

For example, in the field of water and wastewater analysis, on-line analyzers are known that carry out fully automatically the sampling and quantitative determination of an analyte, usually inorganic, in the sample. Such an on-line analysis can be carried out continuously or discontinuously.

From US 2015/0224502 A1, a sample collection device is known for flow-through sampling in waters. The device has a plurality of flow-through sample cartridges which are configured to take in water from the body of water to be monitored and, if necessary, to retain in a filter or adsorption medium samples of components of the liquid or of solids, while the water taken in is returned from the cartridges to the body of water. The samples can either be stored for later laboratory analysis or be analyzed directly in the device. For example, biological substances adsorbed in the filter or adsorption medium can be released as a lysate and made available to an analysis module for further analysis, e.g. by means of qPCR.

At low concentrations of the target substances in the liquid to be analyzed, during sampling the problem arises of providing a sufficient amount of the target substance for the subsequent analysis. With flow-through sampling as described in US 2015/0224502 A1, even low concentrations of dissolved substances or solids present in the water can be retained by conducting a correspondingly large volume of water through the filter medium. However, this is only practicable if the liquid to be analyzed can be returned to the medium after sampling without restrictions, as is the case with the analysis of bodies of water, for example. When monitoring processes, e.g. in water treatment, in the food industry or in the pharmaceutical sector, it is often not possible to reintroduce the removed liquid. Here there is a need for a method for the efficient concentration of sample components to be detected, which makes it possible to keep low the volume of liquid to be removed from the process for analysis.

A further disadvantage of the device described in US 2015/0224502 A1 is that the substance retained in the filter or adsorption medium is transferred from the filter or adsorption medium to the analysis module by lysis and elution. On the one hand, it is to be expected that only a relatively small proportion of the target substance from the filter or adsorption medium enters the analysis module, and on the other hand, a certain minimum volume of liquid is required to rinse out the filter, with the result that the solution entering the analysis module has a relatively large volume with a correspondingly low concentration of the target substance.

The purpose of the invention is to make possible an improved automated on-line detection of a biological target substance in a sample liquid and to provide an improved method or device for the automated on-line detection of a biological target substance in a sample liquid. In particular, the method and the device should make possible an efficient concentration of the target substance and a low-loss transfer of the sample liquid with the concentrated target substance to a downstream detection unit.

This object is achieved by the method for concentrating at least one biological target substance in a sample liquid according to claim 1, by the method for the automated on-line detection of at least one biological target substance in a sample liquid by means of an on-line analyzer according to claim 14, by the concentrator unit for automatically carrying out a concentration of a target substance in a sample liquid according to claim 20, and by the on-line analyzer for detecting at least one biological target substance in a sample liquid according to claim 26. Advantageous embodiments are listed in the dependent claims.

The solution is based on the use of so-called superabsorbers, with which any aqueous sample liquid can be processed in order to concentrate the biomolecules contained in the sample liquid.

Superabsorbers (superabsorbent polymers, SAP) are plastics which are capable of absorbing a multiple of their own weight in polar liquids. These are mainly water or aqueous solutions. When the liquid is absorbed, the superabsorber swells and forms a hydrogel. Hydrogels can be formed by all cross-linked polymers which are polar (e.g., polyacrylamide, polyvinylpyrrolidone, amylopectin, gelatin, cellulose). Usually, however, a copolymer of acrylic acid (propene acid, H2C=CH—COOH) or sodium acrylate (sodium salt of acrylic acid, H2C=CH—COONa) on the one hand and acrylamide on the other hand is used, wherein the ratio of the two monomers to one another can vary. In addition, a so-called core cross-linker (CXL) is added to the monomer solution and connects the long-chain polymer molecules formed with each other in places by chemical bridges, also known as cross-linking. The polymer is water-insoluble because of these bridges. This so-called base polymer is possibly subjected to a so-called surface cross-linking (SXL). A further chemical is applied here to the surface of the particles which, by heating, links a second network only to the outer layer of the grain. This shell supports the swollen gel in order to also hold together under external loading (movement, pressure). In addition to the polyacrylates or other polymers or copolymers based on acrylic acid or acrylate as monomers, others are also possible as superabsorber materials.

The product is traditionally used, for example, as white granules having particle sizes of 100-1000 μm. It is mainly used in baby diapers, sanitary napkins, incontinence care, bandages and, in small amounts, also in cable sheathings for deep-sea cables. Further areas of application are so-called gel beds, gel-forming extinguishing agents in firefighting, as a mechanical stabilizer for cut flowers in a vase or as additive for plant soil in order to save on water on an ongoing basis. However, due to its better environmental compatibility, potassium-neutralized acrylic acid is used here. In the form of spherical particles, the use of superabsorbers as a toy is known, with designations such as “Wasserperlen,” “Aqua Beads” or “Water Beads.” These are superabsorbers which are commercially available in the form of spheres of variable sizes (submillimeters to centimeters).

The invention described here was based on the following unexpected observation. Commercially available so-called water beads (commercially available inter alia under the names Aqua Beads, Water Beads, Wasserbeads, or Gelperlen) were added to a volume of liquid of 1 liter. These water beads are formed from a superabsorber material. The liquid was surface water which had been removed from a firefighting water pond with suspended substances. After an incubation time, the beads had swollen to a multiple of their original volume. The volume of the liquid fraction of the mixture of the liquid and the water beads had reduced. Surprisingly, it was found that the suspended matter of the liquid was not absorbed by the swelling beads. The liquid portion of the mixture including the suspended matter (volume 400 mL) was transferred into a new vessel. A sample with a volume of 50 ml was removed from this liquid fraction.

A comparison sample with a volume of 50 mL was removed directly from the liquid, i.e. the mentioned surface water, without the liquid previously being concentrated according to the method described. Both samples were centrifuged at 5000×g for 10 min. The supernatant was removed and the sediment was used for a nucleic acid extraction. Nucleic acid extraction was effected by means of a commercial kit (innuprep Stool DNA Mini Kit; IST Innuscreen GmbH). The DNA of both samples was then examined by real time PCR for the total bacterial germ count.

It was found that fewer bacteria were detected in the untreated comparative sample than in the sample concentrated with the superabsorber. This means that the bacteria contained in the liquid were not absorbed into the water beads. They were concentrated and were a part of the remaining liquid fraction of the mixture of the liquid and the superabsorber beads. These observations could also be confirmed below for other biomolecules (viruses or eukaryotic cells): After addition of the superabsorber to a volume of liquid containing these biomolecules, the volume was constricted and the biomolecules were concentrated in the remaining residual liquid. It was even more surprising that the method described can also concentrate proteins and free genomic DNA which are located in low concentrations in an aqueous solution.

On the basis of this observation, it was possible to achieve the object of the invention.

The method according to the invention for concentrating at least one biological target substance in a sample liquid comprises:
metering and transporting a first initial volume of the sample liquid via a liquid supply line into a first concentrator chamber of a concentrator unit; and
generating concentrated sample liquid by reducing the first initial volume of the sample liquid in the concentrator unit and associated concentration of biomolecules contained in the first volume of the sample liquid by means of a first amount of a superabsorber, wherein the reduction and the associated concentration is carried out by incubating a mixture formed from the first initial volume of the sample liquid with the first amount of the superabsorber.

The sample liquid obtained after incubation with the superabsorber, which is reduced in volume and has a correspondingly increased concentration of the biomolecules or of the at least one biological target substance contained therein, is also referred to here and in the following as “concentrated sample liquid”.

By reducing the initial volume of the sample liquid after incubation with the superabsorber material to a volume which can be set as desired, and which is accompanied by an increase in the concentration of the biological target substance in the remaining volume of the sample liquid, a comparatively high proportion of the biomolecules obtained from the first initial volume of the sample liquid can be concentrated in a small volume of liquid compared to the method described in the prior art, in which biomolecules are released after binding to a filter medium by rinsing out the filter medium. The method according to the invention thus not only brings about an efficient concentration of the target substance to be determined in the sample liquid, but also makes it possible to select a comparatively small volume for the subsequent analysis, e.g. to be removed from a process, even if the concentration of the target substance in the sample liquid to be examined is low. This makes the method universally suitable for monitoring liquids in a variety of different industrial processes, regardless of whether the volume of sample liquid transported into the process unit has to be discarded after enrichment and disposed of if necessary, or whether it can be returned to the process.

The target substance can be, for example, a biomolecule. The biomolecule can be selected from the group formed of: eukaryotic cells, components of eukaryotic cells, prokaryotic cells, components of prokaryotic cells, subcellular vesicles, bacteriophages, viruses or virus components, toxins, antibodies, nucleic acids, and proteins.

Any aqueous solution can be used as a sample liquid, e.g., water and wastewater samples, fermentation liquids, liquids from foodstuff, chemical, pharmaceutical or biochemical production processes.

The superabsorber may comprise a plastic which absorbs water molecules to form a hydrogel. The superabsorber can be, for example, one of the aforementioned materials. Advantageously, the plastic does absorb water or other polar solvent molecules but not biomolecules, in particular not the target substance. This is the case, for example, with the aforementioned materials and with the superabsorber beads commercially available under the names “Wasserperlen”, “Aqua Beads” or “Water Beads.” The superabsorber can be used, for example, in the form of particles, for example as a powder, as pellets or in the form of geometric bodies, in particular beads. A suitable diameter of the particles, in particular of the beads, is between 100 and 5000 μm.

Generating concentrated sample liquid can comprise metering the first initial volume of the sample liquid to the first amount of the superabsorber placed in the first concentrator chamber, or metering the first amount of superabsorber to the first initial volume of sample liquid placed in the first concentrator chamber.

The incubation of the mixture formed from the first initial volume of the sample liquid with the first amount of the superabsorber can be carried out over a predetermined, in particular selectable, period of time. In general, the increase in concentration of a target substance in the sample liquid that can be achieved within a period of time depends on the type of superabsorber, the particle size of the superabsorber, the size of the first amount of superabsorber added, the temperature prevailing during incubation and the length of the selected incubation period. The period during which the incubation is carried out can be monitored by means of control electronics. In an alternative embodiment, it is also possible to monitor the volume of the liquid portion and to terminate the incubation when a desired, predetermined target volume is reached.

The concentrator chamber and the mixture contained therein can be temperature-controlled during incubation by means of a temperature control device of the concentrator unit. The temperature control device can be a heating and/or cooling device that can be operated automatically by means of control electronics to control and/or regulate the temperature of the mixture present in the concentrator chamber.

The method may further comprise the following step: after incubation, removing at least a portion of the concentrated sample liquid from the first concentrator chamber. The removed liquid can be fed directly into a detection unit of an analyzer. Alternatively, as described below, the concentrated sample liquid can first be fed into a collection vessel. This makes it possible to concentrate the target substance in a plurality of initial liquid volumes extracted as samples, e.g. from a process or a body of water, using the method described and to combine them for further detection. The combined concentrated samples can optionally be further concentrated again using the method described. This procedure is particularly advantageous if the concentration of the target substance in the original, untreated sample liquid is particularly low. The procedure is described in more detail below.

The sample liquid extracted from the concentrator chamber and concentrated in a first stage can first be transported to a collection vessel. Residues of the concentrated sample liquid and the first amount of superabsorber can then be removed from the concentrator chamber, e.g., by rinsing the concentrator chamber with a rinsing fluid, e.g., a rinsing liquid or a rinsing gas.

The method may also include the following steps:
metering and transporting a second initial volume of the sample liquid via a liquid supply line into the first concentrator chamber of the concentrator unit; and
generating concentrated sample liquid by reducing the second initial volume of the sample liquid in the concentrator unit and thereby concentrating biomolecules contained in the second initial volume of the sample liquid by means of a second amount of the superabsorber, wherein the reduction and the associated concentration is carried out by incubating a mixture formed from the second initial volume of the sample liquid with the second amount of the superabsorber, and
transporting at least a portion of the concentrated sample liquid obtained by reducing the second initial volume of the sample liquid from the first concentrator chamber into the collection vessel.

In this way, a plurality of batches of concentrated sample liquid can be generated and combined in the collection vessel. This makes it possible to concentrate a very large volume of sample.

At least a portion of the concentrated sample liquid from the collection vessel can be metered and transported into the first concentrator chamber or into a second concentrator chamber different from the first concentrator chamber for further concentration of the target substance by means of a third amount of the superabsorber. This further concentration is carried out in a completely analogous manner as described for the first concentration, namely by creating a mixture of the concentrated sample liquid and the third amount of superabsorber and incubating the mixture, whereby the volume of the concentrated sample liquid is reduced again and the biomolecules contained therein, including the target substance, are further concentrated. The further concentrated sample liquid obtained in this way can be concentrated again in the same way or fed directly into a detection unit of an analyzer for further analysis. In this way, the sensitivity of the method can be further increased.

In all of the variants described above, the method can advantageously be fully automated by control electronics. For this purpose, the concentrator unit may have means for transporting liquids and for transporting the superabsorber within the concentrator unit, which may include, for example, pumps and/or valves.

The invention also relates to a method for the automated on-line detection of at least one biological target substance in a sample liquid by means of an on-line analyzer. This method includes:
generating concentrated sample liquid from at least a first initial volume of the sample liquid by means of the method described above for concentrating at least one biological target substance in a sample liquid,
transporting at least a portion of the generated concentrated sample liquid from the concentrator unit into a detection unit of the on-line analyzer, and
qualitative or quantitative determination of the target substance in the concentrated sample liquid and/or in the sample liquid, i.e. the original sample liquid before concentration, by means of the detection unit and control electronics of the on-line analyzer.

The qualitative or quantitative determination can be carried out using molecular-genetic methods. In one such advantageous embodiment, the method further comprises the steps of:
releasing and/or isolating nucleic acids from the biomolecules contained in the concentrated sample liquid, in particular the at least one biological target substance, and generating a solution comprising the released and/or isolated nucleic acids,
amplifying at least one target nucleic acid contained in the solution, and
detecting a measurement signal which represents a measurement variable dependent on the progress of the amplification and/or on a number of copies of the target nucleic acid, wherein the control electronics of the analyzer carries out the qualitative or quantitative determination of the target substance in the concentrated sample liquid and/or in the sample liquid before concentration on the basis of the detected measurement signal. The target nucleic acid to be amplified can either be the target substance to be detected or a nucleic acid of the target substance to be detected.

In an advantageous embodiment, the release and/or isolation of nucleic acids from the biomolecules contained in the concentrated sample liquid and the generation of the solution comprising the released and/or isolated nucleic acids is carried out in a first microfluidics unit of the detection unit. The solution is transported into a second microfluidics unit that can be fluidically connected to the first microfluidics unit, and the amplification and detection of the measurement signal is carried out in the second microfluidics unit. The first and second microfluidics units can be housed in two separate cartridges or in a common cartridge.

Releasing and/or isolating nucleic acids from the biomolecules contained in the concentrated sample liquid and generating the solution comprising the released and/or isolated nucleic acids may comprise at least the following steps:
adding one or more lysis reagents to the liquid sample to release nucleic acids of the biomolecules,
binding the released nucleic acids to a nucleic acid binding material; and
washing the bound nucleic acids with a washing solution, and
removing the nucleic acids from the nucleic acid binding material by elution.

In this embodiment, the eluate obtained forms the aforementioned solution comprising the released and/or isolated nucleic acids.

In an alternative embodiment, releasing and/or isolating nucleic acids from the biomolecules contained in the concentrated sample liquid and generating the solution comprising the released and/or isolated nucleic acids may comprise the following steps:
thermal treatment of the biomolecules contained in the concentrated sample liquid in a buffer solution, for example in a phosphate-buffered saline solution, in water, in a tris buffer or in a buffer containing a low concentration of a detergent. In this case, the buffer solution with the nucleic acids released by the thermal treatment forms the aforementioned solution comprising the released and/or isolated nucleic acids.

Thermal release may include dispersion of the sample in the buffered solution and incubation. This method variant is suitable, for example, for applications in which the target substance to be determined is a nucleic acid that is already freely present in the liquid to be analyzed. With this alternative procedure design, classic lysis can therefore be omitted. It is also possible to use the method if the target substance as a biomolecule is a bacterium or a virus. In this case, the biomolecules contained in the sample can be thermally/chemically destroyed and the nucleic acid contained can be released.

The amplification carried out in the second microfluidics unit, for example, can be performed using conventional PCR-based methods. The qualitative or quantitative determination of the target substance can also be carried out in a conventional manner by using a sensor to record at least one measured value of a measured variable at a specific point in time or at a plurality of points in time, which correlates with the number of copies of a target nucleic acid generated by the amplification at the corresponding point in time. From the measured value or measured value curve obtained as a function of time, the presence of the target nucleic acid and thus of the biological target substance in the sample liquid can be detected qualitatively or a quantitative value, e.g. a concentration, of the biological target substance in the original sample liquid or in the sample liquid after concentration can be determined using the method described above and output by the control electronics as a measurement result.

All steps of the method according to the invention described here for the on-line detection of at least one biological target substance in a sample liquid in all specified embodiments can be carried out automatically by means of the control electronics of the on-line analyzer. For this purpose, it can, for example, effect liquid transportation (sample liquid and/or reagents) or solid transportation (superabsorber material) by actuating controllable valves and/or pumps and by controlling and/or regulating the incubation time and temperature during concentration and/or release of nucleic acids by means of a predefined sequence program.

The invention also comprises a concentrator unit for automatically performing a concentration of a target substance in a sample liquid, in particular according to the method described further above, comprising:
a first concentrator chamber;
at least one liquid supply line opening into the first concentrator chamber; and
at least one liquid discharge line opening into the first concentrator chamber, wherein the concentrator unit is configured to add a first amount of a superabsorber to an initial volume of liquid of the sample liquid introduced into the first concentrator chamber via the liquid supply line, or is configured to add the initial volume of liquid to the first amount of the superabsorber.

In one possible embodiment, the first amount of superabsorber can be placed in the first concentrator chamber. In this embodiment, the concentrator chamber can be designed as a replaceable cartridge. When this design is used, with each new batch of sample liquid the replaceable cartridge with the superabsorber can be exchanged for a new cartridge in order to concentrate the target substance.

In an alternative embodiment, the concentrator unit can have at least one reservoir or be connected to a reservoir in which superabsorber, in particular in the form of particles, is contained. Preferably, one of the materials mentioned above is used as a superabsorber, in particular in bead form. Commercially available superabsorber beads having a diameter on the order of 1 mm, which are also commercially available under the names “Wasser-Beads”, “Aqua Beads”, “Water Beads” or “Gelkügelchen” [gel beads], have proven to be very advantageous. Superabsorber beads of this size can be dispersed very well in the concentrator chamber.

The reservoir can, for example, be connected to the first concentrator chamber via a superabsorber supply line that can be closed off by a valve, in particular one that can be controlled by means of control electronics in such a way that, when the valve is open, at least a portion of the superabsorber contained in the reservoir enters the first concentrator chamber as the first amount of superabsorber. The transportation of superabsorbers can be effected by means of gravity. However, it is also possible for the concentrator unit to have means for transporting the superabsorber, for example in the form of particles, e.g. a pump and/or means for generating a gas flow that transports the superabsorber particles. Control electronics designed for automatic operation of the concentrator unit can be used for metering and transporting the superabsorber and are configured to actuate the aforementioned means and/or the aforementioned valve in order to measure out the first amount of superabsorber and transport it into the concentrator chamber. These control electronics can be configured accordingly in conjunction with pumps and/or valves to meter the initial volume of sample liquid into the concentrator chamber.

The concentrator device can have means for moving, in particular stirring, the liquid contained in the reaction chamber. The means may comprise, for example, an agitator, a supply line for an inert gas into the reaction chamber and a discharge line for the inert gas, which lines are arranged so that the inert gas flows through the liquid contained in the reaction chamber, or a drive for moving the reaction chamber.

The concentrator unit can also have a temperature control device which is designed to control the temperature of the first concentrator chamber. The temperature control device can, for example, have heating and/or cooling elements that can be operated by means of the control electronics in order to control and/or regulate the temperature of a liquid contained in the concentrator chamber.

The liquid discharge line for discharging at least part of the liquid volume of the sample liquid present in the first concentrator chamber can be fluidically connectable to a collection vessel.

In a further embodiment, the collection vessel can have a collection vessel discharge line that can be fluidically connected to the first concentrator chamber. In this way, sample liquid already concentrated in a first stage in the collection vessel can be fed back into the first concentrator chamber to be further concentrated in a second stage by again adding superabsorber to the concentrated sample liquid in the first concentrator chamber and incubating the mixture.

In an alternative embodiment, the concentrator unit may comprise an additional second concentrator chamber, wherein the liquid discharge of the first concentrator chamber connects it to the second concentrator chamber, in particular via a collection vessel; and
a further liquid discharge line opening into the second concentrator chamber, wherein the concentrator unit is configured to add a second amount of the superabsorber to a volume of the sample liquid concentrated in the first concentrator chamber that is introduced into the second concentrator chamber or to add the volume of liquid to the second amount of the superabsorber.

The invention also comprises an on-line analyzer for detecting at least one biological target substance in a sample liquid, in particular according to the method described above. The analyzer includes: control electronics;
a concentrator unit according to any of the embodiments described above, wherein the concentrator unit has a liquid outlet for concentrated sample liquid generated in the concentrator unit from the sample liquid; and
a detection unit fluidically connectable to the liquid outlet of the concentrator unit; and at least one transportation device controllable by the control electronics, e.g. a pump, which is configured to transport concentrated sample liquid from the liquid outlet of the concentrator unit into the detection unit,
wherein the control electronics are configured to determine, by means of the detection unit, the target substance in the concentrated sample liquid and/or in the sample liquid before concentration, doing so qualitatively or quantitatively on the basis of a molecular-genetic method.

The on-line analyzer can also have a sample pump, wherein the control electronics are configured to control the sample pump to transport a predetermined volume of the sample liquid into the concentrator unit. The sample feed line can be fluidically connected to a sample reservoir or directly to a body of water or a pipe in a process plant, a fermenter or another process container.

The detection unit can have the following components:
a first microfluidics unit, which can be fluidically connected to a liquid outlet for concentrated sample liquid of the concentrator unit and which is configured to release and/or isolate nucleic acids from biomolecules contained in the concentrated sample liquid, in particular the at least one biological target substance,
a second microfluidics unit connected to the first microfluidics unit and configured to receive an eluate comprising the released and/or isolated nucleic acids and to amplify a target nucleic acid; and
a sensor, in particular an optical sensor, which is configured to generate a measurement signal dependent on the progress of an amplification carried out in the second microfluidics unit and/or on a number of copies of the target nucleic acid in the second microfluidics unit and to output it to the control electronics; and
   wherein the control electronics are configured to determine the biological target substance in the liquid qualitatively and/or quantitatively on the basis of the measurement signal that is output by the sensor.

The liquid outlet of the concentrator unit can be fluidically connected to the aforementioned first concentrator chamber and/or to a second concentrator chamber, if present, and/or to a collection vessel, which is also optionally present. In various design or operating alternatives of the on-line analyzer, concentrated sample liquid can thus be transported into the detection unit directly from the first or the optionally available second concentrator chamber or via the optionally available collection vessel.

The first and second microfluidics units can be arranged together in a cartridge, in particular an replaceable cartridge. Alternatively, the first microfluidics unit can be arranged in a first cartridge and the second microfluidics unit can be arranged in a second cartridge which is different from the first cartridge, wherein the first and second cartridges can be fluidically connected to each other in order to transport liquid from the first cartridge into the second cartridge. The first and second cartridges can be designed to be replaceable.

The first microfluidics unit can be configured to take up the concentrated sample with the biomolecules contained therein and to add one or more lysis reagents in order to release nucleic acids of the biomolecules contained in the sample, then to bind the released nucleic acids, possibly with the addition of a component which reinforces/mediates the binding of the nucleic acid to a nucleic acid binding material, and to wash the nucleic acids bound to this material one or more times with a washing solution. The control electronics can be configured to control the transportation of the particles and optionally the reagents through the first microfluidics unit.

The first microfluidics unit can further be configured to separate the nucleic acids from the nucleic acid binding material by elution and to transport the eluate into the second microfluidics unit via a fluid line connecting the first microfluidics unit to the second microfluidics unit. The control electronics can be configured to control the elution and transportation of the eluate.

In an alternative embodiment, the first microfluidics unit can be configured to receive the concentrated sample with the biomolecules contained therein and to thermally/chemically release the biomolecules in a buffer solution, for example in a phosphate-buffered saline solution (PBS buffer), water or a tris buffer, or optionally a buffer containing a detergent, wherein the control electronics are configured to control the thermal release of the biomolecules and to transport the buffer solution with the biomolecules or nucleic acids dissolved therein into the second microfluidics unit for subsequent amplification. This embodiment is suitable, for example, for use in an application in which the biological target substance to be detected is a nucleic acid freely present in the liquid.

The first microfluidics unit can contain the reaction components required for releasing and/or isolating the nucleic acid in solid form, for example in the form of pellets obtained by lyophilization, or in reagent chambers sealed by microvalves or in reagent packs sealed by films, which can be opened automatically by the application of force or heat, in particular by means of the control electronics.

Reagents for amplification can be stored in an appropriate manner in the second microfluidics unit. It can also contain one or more detection chambers in which the amplification of a target nucleic acid can be carried out or a plurality of different target nucleic acids can be carried out in parallel. The second microfluidics unit can include a temperature control device for the detection chambers. The temperature control device can, for example, have thermoelectric elements that can be controlled by the control electronics.

The control electronics described here and above in connection with the methods according to the invention and the concentrator unit according to the invention can have an electronic data processing device with at least one processor and a memory in which are stored one or more operating programs, which can be executed by means of the processor in order to automatically control the analyzer and to determine qualitative or quantitative analysis results from the measurement signals of the sensor. The operating programs can be designed in such a way that the control electronics control the analyzer in order to carry out the method described above. The control electronics can also have a user interface, e.g. a touch screen or other display in combination with an input keypad. The control electronics can be configured to be connected wirelessly by radio or via a data line to another data processing device, e.g. a computer, a process controller, a display or operating device, in particular a portable one, for communication.

The automatic control of the concentration performed in the concentrator unit can be effected using the same control electronics that are used to control the other components of the analyzer. Alternatively, the concentrator unit can also have its own control electronics, which are configured to automatically concentrate the sample liquid in the manner described. In this embodiment, the control electronics of the concentrator unit are advantageously connected for communication with the analyzer's control electronics, which control the other components of the analyzer, in particular the detection unit.

The analyzer can thus perform on-line determinations of biological target substances in a liquid without the need for manual sampling or preparation or transportation of samples to a laboratory. In particular, the analyzer can perform fully automatic sampling and detection cycles, which can be executed, for example, by the control electronics in an event-driven manner or at predetermined intervals.

In the following, the invention is explained on the basis of the exemplary embodiments shown in the figures. The same reference signs refer to the same components of the components shown in the figures. In the figures:

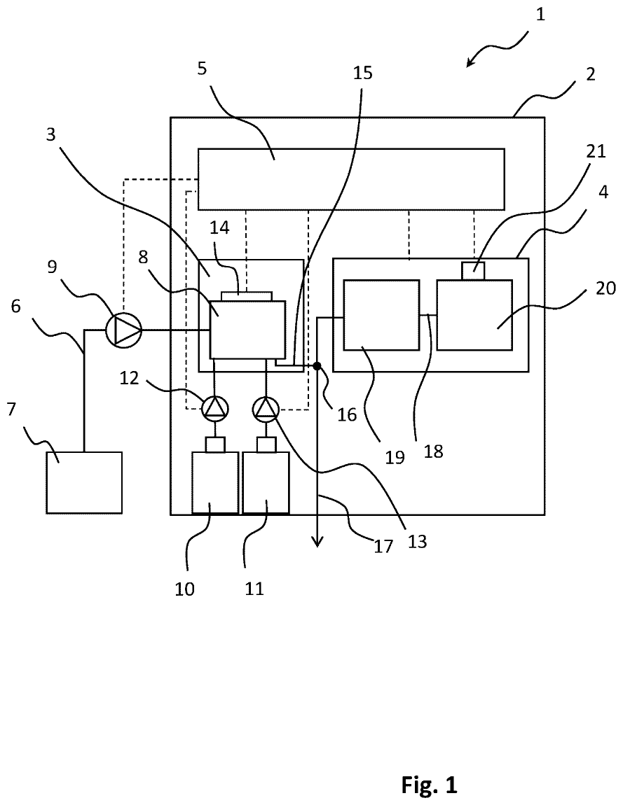

FIG. 1 shows a schematic representation of an on-line analyzer for the qualitative or quantitative determination of a biological target substance in a liquid;

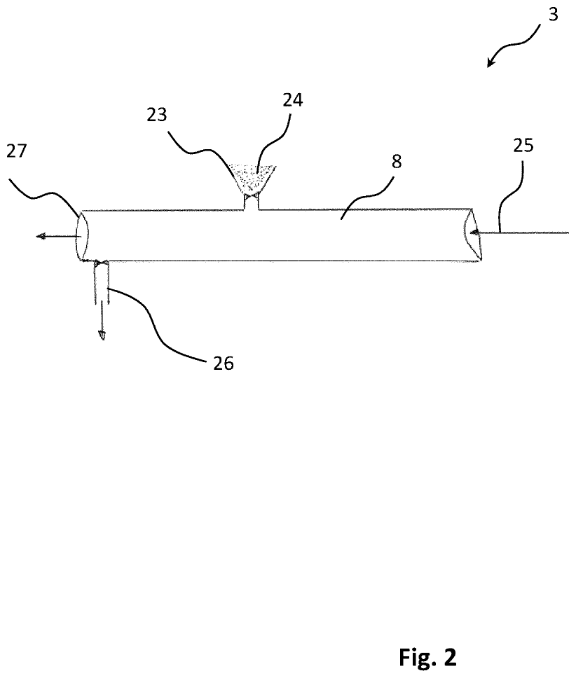

FIG. 2 shows a first exemplary embodiment of a concentrator unit of the on-line analyzer shown in FIG. 1 according to a first exemplary embodiment; and

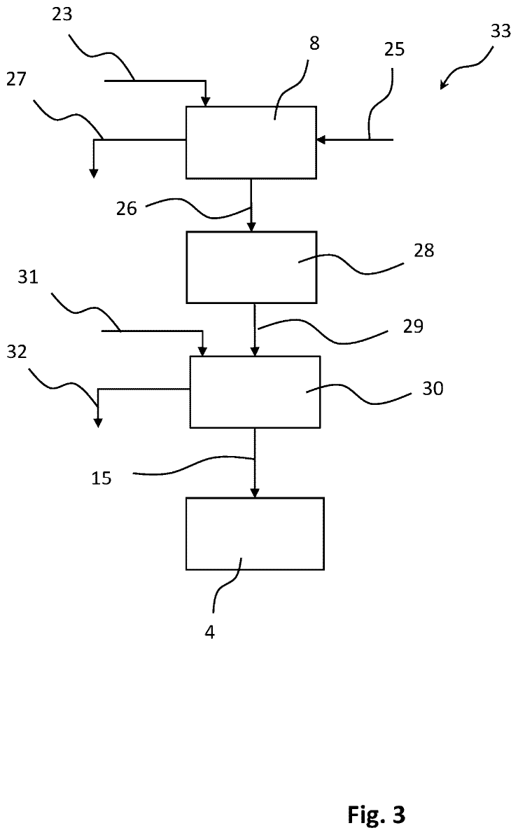

FIG. 3 shows a second exemplary embodiment of a concentrator unit for an on-line analyzer.

FIG. 1 schematically shows an exemplary embodiment of an on-line analyzer 1 for detecting a biological target substance in a sample liquid. In this example, the analyzer 1 has a housing 2 in which all the components of the device are housed. Specifically, these components comprise a concentrator unit 3, a detection unit 4 and control electronics 5. The concentrator unit 3 makes possible the detection of even very low concentrations of biomolecules contained in a sample liquid because it is configured to concentrate biological target molecules in a volume of a sample liquid to be analyzed and to pass the concentrated sample liquid on to the detection unit 4 for detection and, if necessary, for preparatory steps such as extraction and/or isolation of nucleic acids.

The concentrator unit 3 is fluidically connected via a sample supply line 6 to a sample reservoir 7 or to a process container, e.g., a pipe or a reactor or a fermenter, in which the liquid to be analyzed is contained. A pump 9, which can be controlled by the control electronics 5 in accordance with an operating program stored in the control electronics 5 and executed by the latter, is used to transport and meter the liquid from the sample reservoir 7 into a first concentrator chamber 8 contained in the concentrator unit 3. The first concentrator chamber 8 can also be fluidically connected to reservoirs 10, 11. The reservoirs 10, 11 contain substances that serve to enrich the biomolecules contained in the liquid. In the present example, each reservoir 10, 11 is fluidically connected to the concentrator chamber in the concentrator unit 3 via a fluid line. A pump 12, 13 is used to transport the substances contained in the reservoirs through the fluid lines. It is also possible for the reservoirs 10, 11 to be integrated directly into the concentrator unit 3. The transportation of the substances can of course be accomplished by other means known to a person skilled in the art, e.g., pneumatically or by utilizing gravity or, for example, hydrostatic pressure.

The concentrator unit 3 can optionally have a temperature control unit (not shown in FIG. 1), which is used to set a specific temperature in the concentrator chamber 8. The temperature control unit can include resistance heating, cooling and/or thermoelectric elements for optional heating or cooling. It can be connected to the control electronics 5, wherein the control electronics 5 are configured to control or regulate the temperature in the concentrator chamber 8.

The concentrator unit 3 may further comprise a device 14 for moving or stirring a liquid or liquid mixture contained in the reaction chamber 8. In the present example, the device 14 comprises a drive for moving, e.g., shaking, the reaction chamber 8. The device 14, in particular the drive, can be controlled by the control electronics 5.

The concentrator chamber 8 can be fluidically connected either to the detection unit 4 via the fluid line 15 by means of a valve 16 that can be actuated by the control unit 5 or to a liquid outlet 17.

In the present example, the detection unit 4 has an analysis cartridge in which two microfluidics units, namely a first microfluidics unit 19 and a second microfluidics unit 20 fluidically connected to each other via the fluid line 18, are integrated. In another embodiment, the microfluidics units can also be housed in separate cartridges. In this example, the analysis cartridge is replaceable.

The first microfluidics unit 19 is configured to receive a sample containing the concentrated biomolecules from the reaction chamber and to prepare it for subsequent amplification and detection in the second microfluidics unit 20. This can be done using known extraction and isolation methods. For this purpose, the first microfluidics unit 19 comprises reagents and optionally a temperature control unit for incubating reaction mixtures produced in the microfluidics unit 19. To control the transportation of the sample through the first microfluidics unit 19 and to carry out the extraction and/or isolation of nucleic acids, the detection unit 4 comprises suitable means known to a person skilled in the art which can be controlled by the control electronics 5. The second microfluidics unit comprises means for amplification, i.e. reagents and temperature control elements, e.g. thermoelectric elements, as well as means for transporting and aliquoting fluids within the second microfluidics unit 20. To detect the progress of amplification in a manner known per se, for example by means of a real-time PCR-based method, the detection unit has a sensor 21 which can, for example, carry out fluorescence measurements in the second microfluidics unit 20 and can output measurement signals to the control electronics 5. The control electronics 5 are configured to determine a qualitative or quantitative analysis result based on the measurement signals.

The control electronics 5 can be a central processing unit, e.g. a CPU with processor and memory and operating programs stored therein. It can also be divided between a plurality of computing units within the analyzer, e.g. the concentrator unit 3 and the detection unit 4 can each have their own local electronics, which are connected to higher-level electronics for communication, wherein the higher-level electronics and the local electronics together form the control electronics 5.

FIG. 2 shows a schematic detail of a first exemplary embodiment of a concentrator unit 3 of the on-line analyzer 1 shown in FIG. 1. The structure of the concentrator unit 3 shown in FIG. 2 is only one possible exemplary embodiment. A person skilled in the art can come up with a large number of variants without deviating from the inventive concept.

The concentrator unit 3 has a concentrator chamber 8 with various inlets and outlets. The supply line is connected to a reservoir 10, which contains a superabsorber 24, e.g. in the form of beads made of the superabsorber material. The superabsorber 24 is added to the concentrator chamber 8 via the feed line 23. A first opening 25 is used to supply the sample liquid. It is used to feed a specific initial volume of the sample liquid into the concentrator chamber 8. A second opening 26 is connected to the fluid line that connects the reaction chamber (1) to a sample outlet and the detection unit. The second opening 26 can have a diameter that is smaller than the diameter of the superabsorber beads, so that only the liquid portion of the mixture of sample liquid and adsorber can be discharged from the concentrator chamber 8 via the second opening 26 in the direction of the detection unit 4. Optionally, the second opening 26 may also comprise a size selector, for example a grid or a filter, which retains the superabsorber beads in the concentrator chamber 8.

The superabsorber contained in the concentrator chamber 8 and residues of the sample liquid can be removed from the concentrator chamber 8 through a third opening 27 serving as a discharge line, which in the present example is opposite the opening 25 through which the sample liquid can be introduced into the concentrator chamber 8. To completely remove the superabsorber 24 and the residues of the sample liquid, a rinsing liquid or a rinsing gas can be conducted through the concentrator chamber 8. In the present example, the rinsing liquid can, on the one hand, be the sample liquid that is conducted from the sample reservoir 7 through the concentrator chamber 8. Alternatively, the rinsing liquid can be a liquid stored in the reservoir 11. In the latter case, the reservoir 11 is fluidically connected to the first opening 25. Valves that can be actuated by the control electronics 5 are optionally arranged in the corresponding supply lines.

The control electronics 5 can comprise an operating program that it can execute to carry out the following method:
1) Introducing a first initial volume of sample liquid from the sample reservoir 7 into the concentrator chamber 8,
2) Adding a first amount of the superabsorber 24 from the reservoir 10 into the concentrator chamber 8 to the first initial sample liquid volume,
3) Incubating the mixture of the superabsorber 24 and the sample liquid for a period of time measured by the control electronics 5, thereby reducing the volume of the liquid portion of the mixture while concentrating biomolecules, in particular a biological target substance to be determined, in the liquid portion,
4) At the end of the incubation period, discharging the liquid portion.

As described above, the superabsorber absorbs polar solvents, e.g., water in this exemplary embodiment, from the sample liquid to form a gel. Biomolecules, in particular the biological target substance to be determined, are not absorbed by the superabsorber. During incubation, the volume of the liquid portion of the mixture of superabsorber and sample liquid decreases, and the target substance is concentrated in the liquid. The incubation time can be selected to ensure that the concentration of the target substance in the concentrated sample liquid after incubation is above a threshold value, e.g. above a detection limit specified by the detection unit. The time required to achieve the desired volume reduction or concentration depends on the following factors: type of superabsorber, particle size of the superabsorber particles, amount of superabsorber added, temperature during incubation. A suitable amount of superabsorber and incubation time for a specific type of sample liquid can be determined by means of preliminary tests and stored in the control electronics.

The control unit 5 can be designed to set or regulate the temperature of the liquid contained in the concentrator chamber 8 or of the mixture of sample liquid and superabsorber to a constant value by means of the aforementioned temperature control device. All these steps can be carried out automatically by means of the control unit 5. The liquid portion is a concentrated sample liquid, i.e. sample liquid that contains the biological target substance in an increased concentration due to the volume reduction caused by the absorption of water by the superabsorber. The concentrated sample liquid can be transported directly into the detection unit 4 in a possible embodiment according to the exemplary embodiment described here. With the method described here and the concentrator unit 3 described here for carrying out this method, it is possible to reduce a large-volume water sample to a much smaller sample volume and correspondingly achieve a large increase in the concentration of biomolecules. This facilitates and/or accelerates subsequent detection using molecular-genetic methods. If the concentration of biomolecules in the sample liquid is originally very low, the method described here can even permit molecular-genetic detection of the target substance in the first place.

A further advantage results from the fact that the approach according to the invention makes it possible to concentrate bacteria, viruses and free nucleic acids completely non-selectively. Accordingly, it is also very easy to use the method to first concentrate and extract a plurality of different biological target substances and then determine them using a PCR-based method.

The opening 26 of the concentrator unit 3 is fluidically connected to the fluid line 15 of the analyzer 1, which can be connected via the valve 16 to the detection unit 4 on the one hand and to the liquid outlet 17 on the other. The detection of the target substance is described in more detail below: the concentrated sample liquid is transported through the fluid line 15 into the first microfluidics unit 19 via the fluid line 15 by means of the control electronics 5. Another pump can be used for this purpose, which is controlled by the control electronics 5. The valve 16 is also actuated by the control electronics 5. Automated nucleic acid extraction and/or isolation takes place in the first microfluidics unit 19, and automated amplification and detection by means of PCR or real-time PCR takes place in the second microfluidics unit 20 downstream of the first microfluidics unit 19. Microfluidics units for automated nucleic acid extraction, amplification and detection suitable for the method described here are generally known in the prior art. A centrifugal platform as described, for example, in WO 2013/045631 A1 and EP 2 621 632 A1 is advantageous for the present application, but it is also possible to use other microfluidics platforms or lab-on-chip systems that provide for liquid and reagent transportation by means of capillary forces, pumps or pneumatics instead of centrifugal force.

The extraction and/or isolation of the nucleic acids in the first microfluidics unit 19 is carried out using known reagents and methods, as already described at the outset. If the biological target substance is not nucleic acids already freely present in the liquid extracted from the sample, the biomolecules contained in the concentrated sample liquid will be lysed. The free nucleic acids are bound to a nucleic acid binding material, e.g. in particle form. The nucleic acid binding material with the nucleic acids bound to it is subsequently washed in a known manner, and the nucleic acids are finally released from the material. The eluate containing the dissolved nucleic acids is transported into the second microfluidics unit 20, in a manner again controlled by the control electronics 5.

In the second microfluidics unit 20, specific volumes of the eluate are transported into one or more detection chambers and amplification reagents are added. Amplification then takes place in the detection chambers, the progress of which is monitored by means of fluorescence measurements with the sensor 21. The sensor 21 outputs measurement signals to the control electronics 5. This determines on the one hand a qualitative value from the measurement signals, which indicates whether the specific biological target substance is contained in the liquid extracted from the sample 7. Alternatively or additionally, the control electronics 5 can also determine from the measurement signals a quantitative value, which represents a concentration of the biological target substance in the liquid. In an advantageous embodiment, different target nucleic acids can be amplified in a plurality of detection chambers, and thus a plurality of different biological target substances in the liquid can be determined qualitatively or quantitatively in parallel.

Before or after the transfer of the concentrated liquid from the concentrator unit 3 to the detection unit 4 or after detection, the liquid remaining in the concentrator unit 3 is discharged from the process unit 3 through the liquid outlet 17. The concentrator unit 3 can be sufficiently rinsed with a rinsing medium, for example with liquid drawn from the sample reservoir 7, and the process can now be repeated for a further measurement. The microfluidics units 19, 20 in the detection unit can be replaced by new microfluidics units 19, 20 for further measurement. All of the steps described here can be carried out automatically by the control electronics 5.

FIG. 3 schematically shows an alternative exemplary embodiment for a concentrator unit 33, which can be used in the analyzer of FIG. 1 instead of the concentrator unit 3 shown in FIG. 2. The concentrator unit 33 is configured to concentrate a sample liquid in a plurality of stages and thus allows the concentration of even target substances that are only present at an extremely low concentration in the original sample liquid. The concentrator unit 33 has a first concentrator chamber 8, which has an inlet 25 for sample liquid, a feed line 23 for superabsorbers, e.g. in the form of beads having a diameter on the order of 1 mm, and two outlets 26, 27. The supply line 23 for the superabsorber can be connected to a reservoir 10 in which a supply of superabsorber is contained. The first discharge line 26 from the concentrator chamber 8 leads to a collection vessel 28, the second discharge line 27 serves as a discharge line for used liquid and used superabsorber and can, for example, be connected to a waste collection container.

The collection vessel 28 can be fluidically connected to a second concentrator chamber 30 via a liquid discharge line 29. The second concentrator chamber 30 can be designed identically to the first concentrator chamber 8. In the present example, it has a further feed line 31 for superabsorbers, which can be fluidically connected to the same reservoir 10 of the analyzer as the feed line 23 to the first concentrator chamber 8. The second concentrator chamber has a first discharge line 15, which can be fluidically connected to the detector unit 4 of the analyzer in order to supply concentrated sample liquid to the detector unit for the qualitative and/or quantitative detection of the biological target substance. The concentrator chamber 8 has a second outlet 32 for discharging used liquid and/or used superabsorber.

A multi-stage concentration of a target substance in a sample liquid can be carried out by means of the concentrator unit 33, in particular automatically by means of control electronics, e.g. the control electronics 5 of the analyzer, in the following manner: in a first stage, a first initial volume of the sample liquid to be analyzed can be introduced into the first concentrator chamber 8. After adding a first amount of the superabsorber, the resulting mixture can be incubated for a predetermined period of time or until a certain final volume of the liquid portion is reached. At least part of the liquid portion remaining after incineration can then be conducted from the concentrator chamber 8 into the collection vessel 28 via the first outlet 26. Residual liquid and used superabsorber can be discharged from the concentrator chamber via discharge line 27.

In the same way, one or more further initial volumes of the sample liquid can be reduced in the first concentrator chamber 8 in order to concentrate the target substance in these further volumes. After the corresponding incubation, at least a portion of any remaining liquid portion is transferred to the collection vessel 28.

The collected sample liquid, which has already been concentrated in a first stage, can be further concentrated in a second stage by means of the second concentrator chamber 30. For this purpose, at least a portion of the concentrated sample liquid contained in the collection vessel 28 can be introduced into the second concentrator chamber 30 via the discharge line 29 of the collection vessel 28. A second amount of superabsorber is fed into the second concentrator chamber 30 via the superabsorber feed line 31. The mixture thus formed is incubated in the second concentrator chamber 30 for a predetermined period of time and/or until a desired volume of the liquid portion is reached. At least a portion of the liquid portion can then be fed to the detector unit 4 of the analyzer via the liquid line 15. Unused liquid and/or the used superabsorber can be discharged from the second concentrator chamber 30 via the discharge line 32.

All steps of the method described here can be carried out fully automatically by control electronics, e.g. the control electronics 5 of the analyzer 1. For this purpose, the concentrator unit has suitable means for transporting liquid and superabsorber particles through the fluid lines into the various chambers, in particular pumps and valves (not shown in FIG. 3), which the control electronics actuate to carry out the described method for concentrating the target substance in the sample liquid.

The analyzer and method according to the invention thus ideally achieve the object by linking available device systems for detection and makes possible on-line liquid analysis of biological targets, which appears to be particularly advantageous for monitoring water or wastewater in networks, sewage treatment plants or processing plants as well as bodies of water. The method according to the invention makes it possible for the first time to implement molecular-genetic monitoring of biological targets in a practicable and economical manner without manual intervention, starting with a large-volume sample through to detection.

1-32. (canceled)

33. A method for concentrating at least one biological target substance in a sample liquid comprising:
metering and transporting a first initial volume of the sample liquid via a liquid supply line into a first concentrator chamber of a concentrator unit; and
generating concentrated sample liquid by reducing the first initial volume of the sample liquid in the concentrator unit and associated concentration of the at least one biological target substance contained in the first volume of the sample liquid using a first amount of a superabsorber, wherein the reduction and associated concentration is carried out by incubating a mixture formed from the first initial volume of the sample liquid with the first amount of the superabsorber.

34. The method according to claim 33,
wherein the at least one biological target substance is a biomolecule.

35. The method according to claim 33,
wherein the superabsorber comprises a plastic which absorbs water molecules to form a hydrogel.

36. The method according to claim 35,
wherein the plastic does not absorb any biomolecules.

37. The method according to claim 33,
wherein the superabsorber used is in the form of particles.

38. The method according to claim 33,
wherein generating concentrated sample liquid comprises metering the first initial volume of sample liquid to the first amount of superabsorber placed in the first concentrator chamber or metering the first amount of superabsorber to the first initial volume of sample liquid placed in the first concentrator chamber.

39. The method according to claim 33,
wherein the incubation of the mixture formed from the first initial volume of the sample liquid with the first amount of the superabsorber is carried out over a predetermined period of time.

40. The method according to claim 33,
wherein the concentrator chamber and the mixture contained therein are temperature-controlled during incubation using a temperature control device of the concentrator unit.

41. The method according to claim 33,
further comprising:
after incubation, removing at least a portion of the concentrated sample liquid from the first concentrator chamber.

42. The method according to claim 41,
wherein the concentrated sample liquid extracted from the concentrator chamber is transported into a collection vessel.

43. The method according to claim 42,
further comprising:
metering and transporting a second initial volume of the sample liquid via a liquid supply line into the first concentrator chamber of the concentrator unit; and
generating concentrated sample liquid by reducing the second initial volume of the sample liquid in the concentrator unit and associated concentration of biomolecules contained in the second initial volume of the sample liquid by means of a second amount of the superabsorber, wherein the reduction and associated concentration is carried out by incubating a mixture formed from the second initial volume of the sample liquid with the second amount of the superabsorber, and
transporting at least a portion of the concentrated sample liquid from the first concentrator chamber into the collection vessel.

44. The method according to claim 43,
wherein at least a portion of the concentrated sample liquid from the collection vessel is metered and transported into the first concentrator chamber or into a second concentrator chamber different from the first concentrator chamber for further concentration by means of a third amount of the superabsorber.

45. The method according to claim 33,
wherein the method is carried out automatically by control electronics.

46. A method for the automated on-line detection of at least one biological target substance in a sample liquid using an on-line analyzer, comprising:
generating concentrated sample liquid from at least a first initial volume of the sample liquid using the following method:
metering and transporting a first initial volume of the sample liquid via a liquid supply line into a first concentrator chamber of a concentrator unit; and
generating concentrated sample liquid by reducing the first initial volume of the sample liquid in the concentrator unit and associated concentration of the at least one biological target substance contained in the first volume of the sample liquid using a first amount of a superabsorber, wherein the reduction and associated concentration is carried out by incubating a mixture formed from the first initial volume of the sample liquid with the first amount of the superabsorber
transporting at least a portion of the generated concentrated sample liquid from the concentrator unit into a detection unit of the on-line analyzer, and
qualitative or quantitative determination of the target substance in the concentrated sample liquid and/or in the sample liquid before concentration using the detection unit and control electronics of the on-line analyzer.

47. The method according to claim 46,
wherein the method further comprises:
releasing and/or isolating nucleic acids from the biomolecules contained in the concentrated sample liquid and generating a solution comprising the released and/or isolated nucleic acids,
amplifying at least one target nucleic acid contained in the solution, and
detecting a measurement signal which represents a measured variable dependent on the progress of amplification and/or on a number of copies of the target nucleic acid, wherein the control electronics of the analyzer carry out the qualitative or quantitative determination of the target substance in the concentrated sample liquid and/or in the sample liquid before concentration on the basis of the detected measurement signal.

48. The method according to claim 47,
wherein the release and/or isolation of nucleic acids from the biomolecules contained in the concentrated sample liquid and the generation of the solution comprising the released and/or isolated nucleic acids is carried out in a first microfluidics unit of the detection unit,
the solution is transported into a second microfluidics unit which can be fluidically connected to the first microfluidics unit,
and the amplification and acquisition of the measurement signal is carried out in the second microfluidics unit.

49. The method according to claim 47,
wherein the release and/or isolation of nucleic acids from the biomolecules contained in the concentrated sample liquid and the generation of the solution comprising the released and/or isolated nucleic acids comprises at least the following steps:
transferring one or more lysis reagents to the liquid sample to release nucleic acids of the biomolecules,
binding the released nucleic acids to a nucleic acid binding material;
washing the bound nucleic acids with a washing solution, and
removing the nucleic acids from the nucleic acid binding material by elution.

50. The method according to claim 47,
wherein releasing and/or isolating nucleic acids from the biomolecules contained in the concentrated sample liquid and generating the solution comprising the released and/or isolated nucleic acids comprises the following step:
thermal treatment of the biomolecules contained in the concentrated sample liquid in a buffer solution.

51. The method according to claim 46,
wherein the control electronics of the on-line analyzer carry out all method steps automatically.

52. A concentrator unit for automatically performing a concentration of a target substance in a sample liquid, in particular according to the method according to claim 33, the unit comprising:
a first concentrator chamber;
at least one liquid supply line opening into the first concentrator chamber; and
at least one liquid discharge line opening into the first concentrator chamber;
wherein the concentrator unit is configured to add a first amount of a superabsorber to an initial liquid volume of the sample liquid introduced into the first concentrator chamber via the liquid supply line, or is configured to add the initial liquid volume to the first amount of the superabsorber.

53. The concentrator unit according to claim 52,
wherein the first amount of superabsorber is placed in the first concentrator chamber.

54. The concentrator unit according to claim 52,
wherein the concentrator unit has at least one reservoir or is connected to a reservoir in which superabsorber, in the form of particles, is contained and which is connected to the first concentrator chamber via a superabsorber feed line which can be closed off by a valve, using control electronics, in such a way that, when the valve is open, at least a portion of the superabsorber contained in the reservoir enters the first concentrator chamber as a first amount of the superabsorber.

55. The concentrator unit according to claim 52,
further comprising a temperature control device which is designed to control the temperature of the first concentrator chamber.

56. The concentrator unit according to claim 52,
wherein the liquid discharge line can be fluidically connected to a collection vessel for discharging at least a portion of the liquid volume of the sample liquid present in the first concentrator chamber.

57. The concentrator unit according to claim 52,
further comprising an additional second concentrator chamber, wherein the liquid discharge line of the first concentrator chamber connects it via a collection vessel to the second concentrator chamber; and
a further liquid discharge line opening into the second concentrator chamber,
wherein the concentrator unit is configured to add a second amount of the superabsorber to a volume of liquid introduced into the second concentrator chamber of the sample liquid concentrated in the first concentrator chamber or to add the volume of liquid to the second amount of the superabsorber.

58. An on-line analyzer for detecting at least one biological target substance in a sample liquid according to the method according to claim 46, comprising:
control electronics;
a concentrator unit for automatically performing a concentration of a target substance in a sample liquid, the unit comprising:
a first concentrator chamber;
at least one liquid supply line opening into the first concentrator chamber; and
at least one liquid discharge line opening into the first concentrator chamber;
wherein the concentrator unit is configured to add a first amount of a superabsorber to an initial liquid volume of the sample liquid introduced into the first concentrator chamber via the liquid supply line, or is configured to add the initial liquid volume to the first amount of the superabsorber;
wherein the concentrator unit comprises a liquid outlet for concentrated sample liquid generated in the concentrator unit from the sample liquid; and
a detection unit fluidically connectable to the liquid outlet of the concentrator unit; and
at least one transportation device controllable by the control electronics, which are configured to transport concentrated sample liquid from the liquid outlet of the concentrator unit into the detection unit,
wherein the control electronics are configured to determine, using the detection unit, the target substance in the concentrated sample liquid and/or in the sample liquid before concentration qualitatively or quantitatively on the basis of a molecular-genetic method.

59. The on-line analyzer according to claim 58,
further comprising a sample pump, wherein the control electronics are configured to control the sample pump for transporting a predetermined volume of the sample liquid into the concentrator unit.

60. The on-line analyzer according to claim 58,
wherein the detection unit comprises:
a first microfluidics unit which can be fluidically connected to a liquid outlet for concentrated sample liquid of the concentrator unit and which is configured to release and/or isolate nucleic acids from biomolecules contained in the concentrated sample liquid,
a second microfluidics unit connected to the first microfluidics unit and configured to receive an eluate comprising the released and/or isolated nucleic acids and to amplify a target nucleic acid; and
a sensor, which is configured to generate a measurement signal dependent on the progress of an amplification carried out in the second microfluidics unit and/or on a number of copies of the target nucleic acid in the second microfluidics unit and to output it to the control electronics; and
wherein the control electronics are configured to determine on the basis of the measurement signal output by the sensor the biological target substance in the liquid qualitatively and/or quantitatively.

61. The on-line analyzer according to claim 60,
wherein the first and the second microfluidics units are arranged together in a cartridge.

62. The on-line analyzer according to claim 60,
wherein the first microfluidics unit is configured to receive the concentrated sample liquid and to add one or more lysis reagents to release nucleic acids of the biomolecules contained in the concentrated sample liquid, subsequently binding the released nucleic acids to a nucleic acid binding material, optionally with the addition of a component which reinforces or mediates the binding of the nucleic acids to a nucleic acid binding material, and washing the nucleic acids bound to the material one or more times with a washing solution.

63. The on-line analyzer according to claim 62,
wherein the first microfluidics unit is further designed to separate the nucleic acids from the nucleic acid binding material by elution and to transport the eluate into the second microfluidics unit via a fluid line connecting the first microfluidics unit to the second microfluidics unit, and wherein the control electronics are configured to control the elution and the transportation of the eluate.

64. The on-line analyzer according to claim 61,
wherein the first microfluidics unit is further designed to receive the concentrated sample and to thermally and/or chemically release the nucleic acids from the biomolecules contained in the concentrated sample in a buffer solution, wherein the control electronics are configured to control the thermal treatment in the buffer solution and to transport the buffer solution with the released nucleic acids into the second microfluidics unit.
